(19) United States
(12) Patent Application Publication
(10) Pub. No.: US 2007/0137733 A1
(43) Pub. Date: Jun. 21, 2007

(54) Mixed rare-earth based high-coercivity permanent magnet

(76) Inventors: Shengzhi Dong, Shanghai (CN); Juliana Chiang Shei, Niskayuna, NY (US); Jianmin Wang, Shanghai (CN)

Correspondence Address: Patrick S. Yoder;FLETCHER YODER, P.O. Box 692289, Houston, TX, 77269-2289, US

(21) Appl. No.: 11/314,289

(22) Filed: Dec. 21, 2005

(51) Int. Cl. H01F 1/057

(52) U.S. Cl. 148/105; 148/302

(57) ABSTRACT

A system and method for a permanent magnet, having boron, iron, and a rare-earth material. The rare-earth material includes neodymium, at least 50 weight percent praseodymium, 0-20 weight percent terbium, and 5-25 weight percent dysprosium, wherein the permanent magnet comprises an intrinsic coercivity of at least 17 kilo Oersteds. Due to this high intrinsic coercivity, the permanent magnet may be subjected to high-temperature (e.g., greater than 80° C.) applications (e.g., as a component of a motor, generator, and so forth). In one exemplary application, a generator within a commercial wind turbine or windmill incorporates 3 tons of the permanent-magnet material.

### BACKGROUND

The invention relates generally to permanent magnets and more particularly to high-temperature permanent magnets (HTPM) having high coercivity and where at least half of the rare-earth content is praseodymium.

Permanent magnets containing rare-earth metals (e.g., neodymium or Nd) are employed in computers, motors, generators, automobiles, wind turbines or windmills, laboratory equipment, medical systems, and other equipment and devices. Certain devices employing permanent magnets may be exposed to a working environment having high temperatures (e.g., greater than 80° C.). The permanent magnet (PM) material component of these devices should be able to provide an adequate magnetic field (e.g., at the working area/gap) within the expected working temperature range. In meeting this need, the PM material should retain its particular magnetic properties, such as remanence and coercivity, at sufficient levels when exposed to the expected higher temperatures. Such retention of magnetic properties may be beneficial when these devices are operating normally or in allowable failure conditions.

Generally, PM material capable of working at high temperature (e.g., greater than 80° C., 100° C., etc.) may be called high-temperature permanent magnets (HTPMs). An example of HTPMs commercially available is high-coercivity neodymium-iron-boron (NdFeB) magnets which are typically a more economical alternative to the other HTPMs, such as aluminum nickel cobalt (AlNiCo) magnets and samarium cobalt (SmCo) magnets. Advantageously, NdFeB magnets generally possess a higher energy product than AlNiCo and SmCo magnets. Moreover, cobalt (Co) or other elements may replace a portion of the iron (Fe) in the NdFeB magnet, for example, to increase the Curie temperature and to further improve the thermal stability of the NdFeB magnet. The Curie temperature (Tc) is generally the temperature at which the parallel alignment of elementary magnet moments dissipates, and the material does not hold its magnetization. In sum, due to the relatively lower cost and higher energy product, NdFeB magnets, especially those having high coercivity, e.g., greater than 14 kilo Oersteds (kOe), 15 kOe, 16 kOe, 17 kOe, etc., are used in high-temperature applications, such as in motors and generators, for example.

Coercivity is a property of the HTPM that represents the amount of demagnetizing force needed to reduce the induction of the HTPM to zero after the magnet has previously been brought to saturation. Typically, the larger the coercivity or coercive force (Hc), the greater the stability of the magnet in a high-temperature environment and the less it is affected by an external magnetic field. The intrinsic coercivity or intrinsic coercive force (Hcj) of the magnet is the magnetic material's inherent ability to resist demagnetization corresponding to zero value of intrinsic induction (J). Again, practical consequences of high intrinsic coercivity Hcj values are greater temperature stability for a given class of material, and greater stability in dynamic operating conditions.

High-coercivity NdFeB magnets are typically mixed rare-earth materials, commonly consisting of the rare-earth metals terbium (Tb) and dysprosium (Dy) as auxiliary components, replacing a portion of the rare-earth metal neodymium (Nd) in the magnet to further enhance the intrinsic coercivity Hcj of NdFeB magnets for high-temperature applications. With the increase of the application of NdFeB magnets in motor type devices, generators, and other devices, the consumption of terbium and dysprosium has become significant. Unfortunately, terbium and dysprosium are more rare than Neodymium and their deposits are limited. For example, the annual output of terbium is only hundreds of tons while the annual output of neodymium is thousands of tons (e.g., 10,000 tons). Consequently, the price of terbium is much higher (e.g., 50 times) than neodymium. This price difference increases with the growing demand for high-coercivity NdFeB magnets in high-temperature applications. In sum, a high-coercivity magnet has been traditionally obtained with a NdFeB-based magnet having terbium and dysprosium as a substitute of part of the neodymium. With the mounting use of these types of magnets, the terbium and dysprosium are expected to be in short supply.

There is a general need for more economical NdFeB-based magnets and available supply of raw materials for the NdFeB-based magnets. There is a particular need to address the availability and cost of terbium and dysprosium for high-coercivity NdFeB-based magnets employed in high-temperature environments.

### BRIEF DESCRIPTION

In one embodiment of the present technique, a permanent magnet includes boron, iron, and a rare-earth material. The rare-earth material comprises neodymium, at least 50 weight percent praseodymium, 0-20 weight percent terbium, and 0-25 weight percent dysprosium, wherein the permanent magnet comprises an intrinsic coercivity of at least 14 kOe in one embodiment and 17 kOe in another embodiment. Moreover, cobalt or M, or a combination thereof, may be substitute for a portion of the iron, where M includes aluminum, copper, chromium, vanadium, niobium, or gallium, or zirconium, or any combination thereof.

In an example, a machine has a permanent magnet, the permanent magnet including: boron; iron, cobalt, or M, or a combination thereof, wherein M comprises aluminum, vanadium, niobium, copper, niobium, or gallium, or zirconium, or any combination thereof; and a rare-earth material comprising neodymium, at least 50 weight percent praseodymium, 0-20 weight percent terbium, and 0-25 weight percent dysprosium. Further, the permanent magnet is adapted to operate in a temperature environment of at least 80° C. within the machine.

Another embodiment relates to a method of operating a motor or generator having a permanent magnet, the method including operating the motor or generator at an internal operating temperature of at least 80° C. and exposing the permanent magnet to the internal operating temperature. The permanent magnet includes boron, iron, and rare-earth material, wherein the rare-earth material comprises neodymium, at least 50 weight percent praseodymium, 0-20 weight percent terbium, and 0-25 weight percent dysprosium.

Yet another embodiment relates to a method of manufacturing a permanent magnet, the method including: forming an alloy or ingot or strips comprising boron, iron, and rare-earth material, wherein the rare-earth material comprises neodymium, at least 50 weight percent praseodymium, 0-20 weight percent terbium, and 0-25 weight percent dysprosium; converting the alloy or ingot or strips to particulates; compacting and sintering the particulates; and aging the compacted and sintered particulates.

### DRAWINGS

These and other features, aspects, and advantages of the present invention will become better understood when the following detailed description is read with reference to the accompanying drawings in which like characters represent like parts throughout the drawings, wherein:

FIG. 1 is a plot of three demagnetization curves corresponding to three magnet samples of Example I in accordance with embodiments of the present technique;

FIG. 2 is a plot of three demagnetization curves corresponding to three magnet samples of Example II in accordance with embodiments of the present technique;

FIG. 3 is a plot of four demagnetization curves corresponding to four magnet samples of Example III in accordance with embodiments of the present technique; and

FIG. 4 is plot of coercivity as a function of praseodymium substitution of neodymium and the terbium concentration of the rare-earth content.

### DETAILED DESCRIPTION

There present invention addresses the risk of short supply of terbium and dysprosium by reducing the requirement of terbium and dysprosium in the mix rare-earth magnet. The technique provides for mixed rare-earth (RE) permanent magnets of the (RE)FeB type having high coercivity (e.g., greater than 14 kilo Oersteds or 1,114 kilo amps/meter, greater than 17 kOe, etc.) to accommodate, for example, high-temperature applications, yet having reduced amounts of terbium and dysprosium relative to traditional (RE)FeB HTPMs. Such reduction in the use of terbium and dysprosium generally reduces the cost of the REFeB HTPM. To accomplish this decrease of terbium and dysprosium while retaining high coercivity and the magnetization or remanence of the magnet, the metal praseodymium (Pr) is employed in the magnet at concentrations of greater than 50 weight % of the total rare-earth material. Further, the concentrations of terbium and dysprosium are balanced at 0-20 weight % and 0-25 weight % of the total rare earth (RE), respectively. In certain embodiments, dysprosium is at 5-25 weight % of the rare earth. Moreover, as discussed below, the sintering and aging temperatures may be adjusted to retain coercivity while accommodating the reduction in terbium and dysprosium.

These mixed rare-earth magnets having high coercivity according to the present invention may be labeled as a PrFeB-based magnet because the praseodymium content is more than 50% of the total rare earth. Again the presence of 50% or greater praseodymium, in part, permits the reduction in the concentration the auxiliary rare-earth components terbium and dysprosium as compared with the traditional NdFeB magnet having comparable energy product and coercivity.

In particular, the permanent magnets according to embodiments of the present technique are PrFeB-based magnets having the composition (Pr, Nd, Tb, Dy)—(Fe, Co, M)—B, in which praseodymium comprises at least 50 weight % of the total rare-earth content and in which at least neodymium, terbium, and/or dysprosium comprise the balance (50 weight % or less) of the total rare earth. Moreover, cobalt (Co) and other metals M, such as aluminum (Al), copper (Cu), neobium (Nb), gallium (Ga), and/or zirconium (Zr), and the like, may be substitutes for a portion of the iron (Fe). These magnets may function in operating environments (or have design conditions) of greater than 80° C., 90° C., 100° C., 110° C., 120° C., 130° C., 140° C., 150° C., 160° C., 170° C., 180° C., and so on. Exemplary operating or design ranges of the present permanent magnet include 80-180° C., 100-180° C., 110-170° C., 110-160° C., 120-150° C., 130-140° C., and so forth

In certain embodiments, the main phase of the present magnet material or alloy is Pr₂Fe₁₄B. This Pr₂Fe₁₄B phase material is compared to other possible phases of the magnet in Table 1 below. In this tabulated comparison, the magnetocrystalline anisotropy field (H_{A}) (indicator of intrinsic coercivity) and molecular moment (μₘ) (indicative of remanence) of different R₂Fe₁₄B (R=Pr, Nd, Tb, Dy) phases are listed.

TABLE 1
Exemplary Comparison of Intrinsic Magnetic Properties
of (RE)₂Fe₁₄B at Room Temperature

| | Pr₂Fe₁₄B | Nd₂Fe₁₄B | Tb₂Fe₁₄B | Dy₂Fe₁₄B |
|---|---|---|---|---|
| H_{A} (kOe) | 79 | 70 | 220 | 158 |
| μₘ (μ_{B}) | 31.0 | 32.2 | 15.5 | 14.1 |

In this tabulated example, Nd₂Fe₁₄B presents the highest moment μₘ but the lowest anisotropy H_{A}. Therefore, as indicated, to manufacture a high-coercivity magnet, traditionally, terbium and dysprosium are added to NdFeB-based material or alloy to enhance the average crystalline anisotropy, and thus, to increase the intrinsic coercivity. However, the addition of terbium and dysprosium will usually reduce the saturation magnetization (remanence) of the NdFeB magnet since the molecular moments μₘ of Tb₂Fe₁₄B and Dy₂Fe₁₄B are typically smaller than that of Nd₂Fe₁₄B. Consequently, it is sometimes a tradeoff to obtain either high coercivity or high magnetization (remanence). In certain embodiments, remanence is at least 10 kilo Gauss (1 Tesla).

However, the Pr₂Fe₁₄B phase material, as listed in the example of Table 1, possesses a 12% higher anisotropy H_{A} (indicative of coercivity) than Nd₂Fe₁₄B material, though the molecular moment μₘ (indicative of remanence) of Pr₂Fe₁₄B is somewhat lower, about 3.7% lower in this example. With the advantage of higher anisotropy field, the present PrFeB-based magnet, as indicated by these embodiments, generally provides for high-coercivity magnets suitable for functioning in high-temperature environments as a HTPM.

For illustration purposes, a prophetic comparison of particular compositions of a PrFeB-based HTPM and a conventional NdFeB-based HTPM assumes that the total rare-earth (RE) occupies 31.5 weight % of the total magnet material or alloy for high-temperature applications. For the example of incorporating terbium to enhance the anisotropy field of the material, and therefore, to increase the intrinsic coercivity, the conventional NdFeB-based high-coercivity magnet has a terbium content of about 1.5 weight % (of the magnet) to provide for the high coercivity (as used herein, coercivity generally refers to intrinsic coercivity).

In contrast, in a present embodiment, the anisotropy of a PrFeB-based magnet is increased by only utilizing about 0.5 weight % Tb content of the magnet, as calculated, to provide for similar anisotropy field and high coercivity. Beneficially, the average molecular moments of these two different-based magnets, Nd₃₀Tb_{1.5}(Fe—B)_{68.5} and Pr₁₆Nd₁₅Tb_{0.5}(Fe—B)_{68.5}, in this example, are comparable, indicating that their magnetization (remanence) and energy product (BH)max will be likely be comparable. The principle of incorporating less terbium by adding praseodymium while maintaining coercivity without substantial loss of remanence and energy product are also applicable to the dysprosium addition cases.

Table 2 is an exemplary cost model of conventional NdFeB magnet versus mixed rare-earth (Pr,Nd)—Fe—B magnet. It is evident that if the terbium concentration can be reduced from about 1.5 weight % to about 0.5 weight %, the total cost may decrease although the unit price of the added praseodymium may be higher than that of the removed neodymium. A reason is that the terbium (and dysprosium if used) is very expensive relative to Pr. Indeed, the amount of the very rare terbium (and dysprosium) employed may have a great effect on the price of the magnet. Therefore, the process of the magnet is generally less expensive even though the somewhat expensive praseodymium is added in place of the relatively inexpensive neodymium amount of the very rare terbium in the magnet may significantly affect the raw-material price of the magnet. The present technique provides for new composition magnets having relatively lower amounts or no terbium.

With the conventional HTPM having 1.5% Tb, the exemplary cost is $10.8 per kilogram, whereas an exemplary cost of an embodiment of the present HTPM having the significant content of Praseodymium but only 0.5% Tb has an exemplary cost of $6.7 per kilogram, $3.2 per kilogram less than the conventional HTPM. The unit cost of the magnet material is reduced, and therefore, the price of the application or the end product may be reduced. In one embodiment, the application is a wind turbine or windmill having a generator employing a high-coercivity HTPM (e.g., 3 tons of HTPM material in the generator).

In the tabulated example, the total amount of rare-earth is about 31.5 weight percent of the total magnet material in both the conventional NdFeB HTPM and in the present mixed rare-earth PrFeB. HTPM. The PrFeB. HTPM has praseodymium of at least 50 weight % of the 31.5% of rare-earth material. It should be emphasized that the rare-earth weight concentration of the magnet may vary, e.g., 25%, 26%, 27%, 28%, 29%, 30, %, 31%, 32%, 33%, 34%, 35%, and soon.

TABLE 2
Comparison of Exemplary Raw Material Costs of a
Conventional PM versus a Mixed Rare-Earth HTPM

| | Conventional NdFeB | | | Mixed Rare-Earth HTPM | | |
|---|---|---|---|---|---|---|
| Material | wt % | $/kg | Cost($) | wt % | $/kg | Cost($) |
| Tb | 1.5 | 457.8 | 6.9 | 0.5 | 457.8 | 2.3 |
| Co | 1.2 | 60.2 | 0.7 | 1.2 | 60.2 | 0.7 |
| Fe | 62.3 | 0.5 | 0.3 | 62.3 | 0.5 | 0.3 |
| Fe—B₂₂ | 5 | 3.4 | 0.2 | 5 | 3.4 | 0.2 |
| Nd | 30 | 9.2 | 2.7 | | | |
| Nd₇₅Pr₂₀ | | | | 20 | 8.9 | 1.8 |
| Pr | | | | 11 | 13.3 | 1.5 |
| Total | 100 | | 10.8 | 100 | | 6.7 |

The following examples are set forth to provide those of ordinary skill in the art with a detailed description of how the methods claimed herein are evaluated, and are not intended to limit the scope of what the inventors regard as their invention.

### EXAMPLE I

In Example I, the effect of praseodymium substitution for neodymium on the magnetic properties of a NdFeB material or alloy is presented. The exemplary composition evaluated is (PrₓNd₁₋ₓ)₃₂Fe_{balance}Co₁Cu_{0.1}Nb₁B_{1.1}, where x=0, 0.25, 0.5, 0.75, and 1. Manufacturing process parameters in this Example I sintering of the HTPM at 1090° C. for two hours and aging at 900° C. for one hour and then at 600° C. for two hours. As can be seen from the results presented in Table 3 below, with the increasing increment of praseodymium substitution for neodymium, the remanence Br is generally decreasing, the intrinsic coercivity Hcj increases significantly, and the maximum energy product (BH)max decreases slightly.

TABLE 3
HTPM Remanence (Br), Intrinsic Coercivity (Hcj), and
Maximum Energy Product (BH)max versus the Pr Weight
Fraction (x) of the Rare-Earth Material (Example I)

| x | Br (kGs) | Hcj (kOe) | (BH)max (MGOe) |
|---|---|---|---|
| 0 | 12.14 | 9.10 | 34.0 |
| 0.25 | 12.16 | 9.55 | 34.2 |
| 0.5 | 11.99 | 9.64 | 32.5 |
| 0.75 | 12.06 | 10.07 | 30.8 |
| 1.0 | 11.70 | 10.22 | 26.5 |

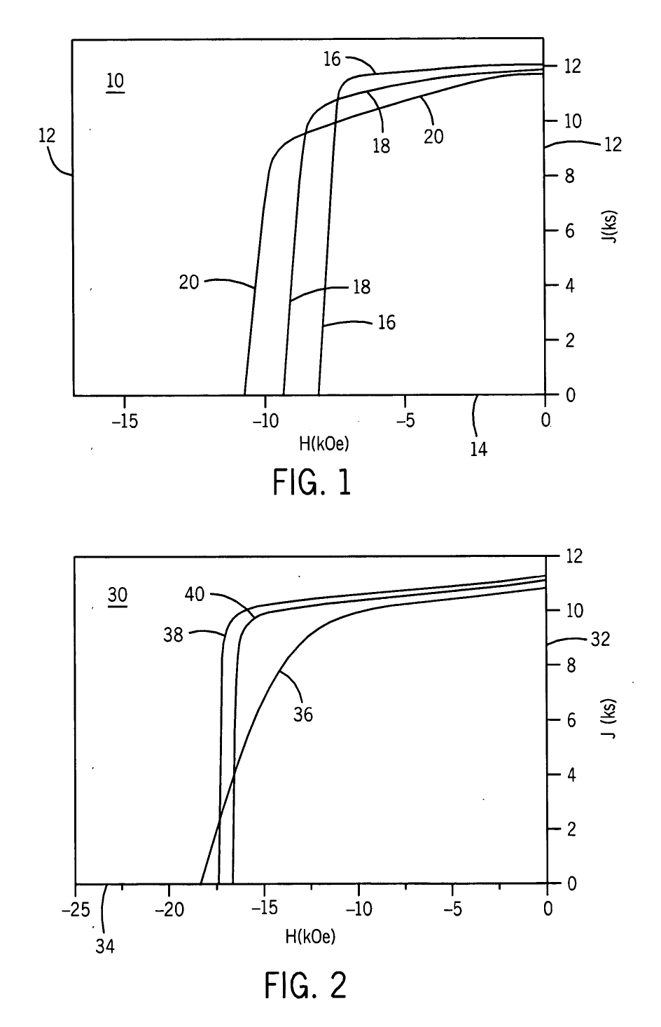

Turning now to the drawings, FIG. 1 is the demagnetization plot 10 of the HTPM of Example I. The intrinsic induction (J) 12 in kilo Gauss is plotted versus the magnetic field (H) 14 in kilo Oersteds. The fraction of the (PrₓNd₁₋ₓ)₃₂Fe_{balance}Co₁Cu_{0.1}Nb₁B_{1.1} magnet is x=0, 0.5, and 0.75 (or Nd, Pr_{0.5}Nd_{0.5}, and Pr_{0.75}Nd_{0.25}), as depicted by curves 16, 18, and 20, respectively. In Example I, praseodymium substitution for neodymium can increase coercivity of the NdFeB magnet by about 12% (i.e., from 9.10 to 10.22 kOe). The remanence Br and energy product (BH)max will decrease to some extent with the increase of praseodymium. Lastly, it should be noted that for a certain composition, the properties of the HTPM may be affected by the manufacturing system and process parameters, such as sintering and aging temperatures/times.

### EXAMPLE II

Example II considers the effect of praseodymium content on the magnetic properties of the NdFeB alloy having high coercivity (e.g., greater than 14, kOe, 17 kOe, etc.). The composition of the HTPM in Example II is (PrₓNd₁₋ₓ)₂₉Dy₆Fe_{balance}Co₁Cu_{0.1}Nb₁B_{1.1}, where x=0, 0.5, and 1 (of total magnet). As with the magnets of Example I, the magnet samples in Example II were sintered at 1090° C. for two hours and aged at 900° C. for one hour and then aged at 600° C. for two hours. For the results in table 4 below, with dysprosium at 6 weight % of the rare-earth material and with increasing praseodymium substitution of neodymium, Br decreases slightly, Hcj decreases slightly (did not increase as initially expected), and (BH)max has a maximum. In conclusion, it is believed that the sintering and aging temperatures, and other process parameters, may be adjusted for this composition of this dysprosium example (6 weight % of rare earth) to provide for increasing coercivity Hcj with increasing Pr substitution of Nd.

TABLE 4
HTPM Remanence (Br), Intrinsic Coercivity (Hcj), and
Maximum Energy Product (BH)max versus the Pr Weight Fraction
(x) of the Rare-Earth Material (Example II)

| x | Br (kGs) | Hcj (kOe) | (BH)max (MGOe) |
|---|---|---|---|
| 0 | 11.27 | 18.9 | 27.1 |
| 0.5 | 11.16 | 17.8 | 29.1 |
| 1.0 | 11.04 | 16.1 | 28.5 |

Referring to FIG. 2, the substantially horizontal slope of the demagnetization curves in plot 30 for the magnet samples of Example II further confirms that the process conditions (e.g., sintering and aging temperatures/times) of the HTPM manufacture should be altered for this particular composition having dysprosium as 6 weight % of the rare-earth content of the magnet. In FIG. 2, the intrinsic induction (J) 32 in kilo Gauss is plotted versus the magnetic field (H) 34 for the three magnet materials having x=0, 0.5, and 1.0, as indicated by curves 36, 38, and 40, respectively. A conclusion is that beneficial process parameter ranges may be different for dissimilar compositions. Moreover, fixed parameter values, such as the temperature values for sintering and aging, can mislead understanding of the expected trend of the positive impact the addition of terbium and/or dysprosium to enhance intrinsic coercivity.

### EXAMPLE III

The effect of terbium concentration on magnetic properties is examined in Example III. The HTPM compositions in this example are Nd₂₇₋ₓTbₓDy₅Co₁Cu_{0.1}Nb₁B_{1.1}, where x=0, 0.5, 1, 1.5 of total magnet. Sintering was conducted at 1090° C. The samples were then aged at 900° C. for one hour and at 600° C. for two hours. As can be seen from table 5 below, with the increase of terbium from 0 to 1.5 weight %, the intrinsic coercivity Hcj increased about 27% with remanence Br only decreasing by about 3% and (BH)max decreasing by 6%.

TABLE 5
HTPM Remanence (Br), Intrinsic Coercivity (Hcj), and Maximum
Energy Product (BH)max versus the Pr Weight Fraction (x)
of the Rare-Earth Material in Example III.

| x | Br (kGs) | Hcj (kOe) | (BH)max (MGOe) |
|---|---|---|---|
| 0 | 11.48 | 16 | 30.5 |
| 0.5 | 11.32 | 18 | 29.5 |
| 1.0 | 11.19 | 19 | 29.2 |
| 1.5 | 11.09 | 21 | 28.7 |

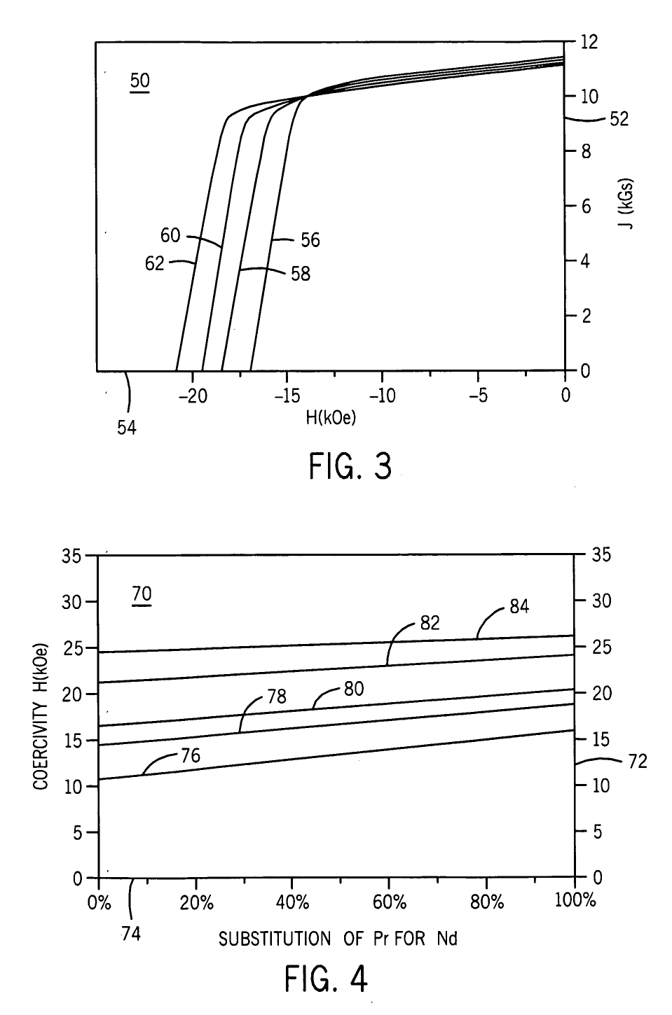

Referring to FIG. 3, a plot 50 of the demagnetization curves of the four magnet compositions of Example III is provided. The intrinsic induction (J) 52 in kilo Gauss is plotted versus the magnetic field (J) in kilo Oersteds. The demagnetization curves 56, 58, 60, and 62 are plotted for the four compositions of Tb of x=0, 0.5, 1, and 1.5, respectively. This example further supports that increasing concentrations of terbium play a significant role in increasing coercivity of the permanent magnet.

### EXAMPLE IV

Statistical analysis provided for an exemplary transfer function correlating two process factors of sintering temperature and aging temperature and two composition factors of praseodymium and terbium concentrations with performance properties of the magnet. The composition formula for this statistical example is (Pr₁₋ₓNdₓ)_{32-y}Tb_{y}Fe_{balance}Co1Cu0_{.1}Nb₁B_{1.1}. The factor values of the analysis are presented in table 6.

TABLE 6
Development of Transfer Function

| | | | Tb | | | |
|---|---|---|---|---|---|---|
| | | Pr Fraction | Wt % | | | |
| Sinter T | Aging T | Substitution | of Total | Br | Hcj | (BH)max |
| ° C. | ° C. | of Nd* | Magnet | kGs | kOe | MGOe |
| 1090 | 570 | 0 | 0 | 12.65 | 9.933 | 37 |
| 1120 | 570 | 0 | 0 | 12.7 | 9.338 | 37.06 |
| 1090 | 630 | 0 | 0 | 12.59 | 10.61 | 36.41 |
| 1120 | 630 | 0 | 0 | 12.66 | 10.21 | 36.48 |
| 1090 | 570 | 0.75 | 0 | 12.52 | 13.09 | 35.76 |
| 1120 | 570 | 0.75 | 0 | 12.7 | 12.48 | 36.98 |
| 1090 | 630 | 0.75 | 0 | 12.58 | 14.86 | 36.17 |
| 1120 | 630 | 0.75 | 0 | 12.63 | 13.95 | 37.01 |
| 1090 | 570 | 0 | 5 | 10.6 | 27 | 26.22 |
| 1120 | 570 | 0 | 5 | 11.61 | 25.75 | 31.25 |
| 1090 | 630 | 0 | 5 | 10.63 | 28.04 | 26.28 |
| 1120 | 630 | 0 | 5 | 11.64 | 26.58 | 31.79 |
| 1090 | 570 | 0.75 | 5 | 10.21 | 27.82 | 24.08 |
| 1120 | 570 | 0.75 | 5 | 11.36 | 24.88 | 30.1 |
| 1090 | 630 | 0.75 | 5 | 10.17 | 28.93 | 23.77 |
| 1120 | 630 | 0.75 | 5 | 11.27 | 26.08 | 29.47 |

*A 0.75 fraction substitution of Pr for Nd can be converted to Pr weight % of rare-earth by subtracting the weight percent concentrations of Tb and Dy from 75% at the Pr is about weight of the rare-earth content.

TABLE 7
Components and Coefficients of Transfer Function
Correlating Four Factors with of Hcj

| Components | Actual Coefficient | p |
|---|---|---|
| Constant | 5.372 | 1.1507E−16 |
| Sinter T | −0.00594 | 3.044E−05 |
| Aging T | 0.01869 | 0.00013135 |
| Pr | 49.02 | 3.6989E−06 |
| Tb | 14.39 | 2.1603E−13 |
| Sinter T*Pr | −0.04006 | 0.02497418 |
| Sinter T*Tb | −0.00998 | 0.00182777 |
| Pr*Tb | −0.9299 | 5.2972E−06 |

The exemplary transfer function is:
Hcj=5.732−0.00594*SinterT+0.01869*AgingT+49.02Pr+14.39*Tb−0.4006*sinterT*Pr−0.00998*SinterT*Tb−0.9299*Pr*Tb.

From this correlation, it can be seen that the concentration of the rare-earth content of praseodymium has a varying effect on intrinsic coercivity Hcj for different concentrations of the rare-earth content of terbium. In general, the less the concentration of terbium in the rare-earth portion of the magnet, the greater the impact on intrinsic coercivity Hcj with increasing concentration of praseodymium of the rare-earth content. Referring to FIG. 4, a plot 70 of the transfer function correlating coercivity Hcj 72 in kilo Oersteds versus the amount of substitution 74 of Praseodymium for Neodymium in percent is given for various concentrations of terbium of the rare-earth, of 0, 1, 2, 3, and 4 weight %, as represented by lines 76, 78, 80, 82, and 84, respectively.

Expected results are presented in table 8. Two particular cases, namely Example A and Example B, were examined, a first magnet having 3 weight % terbium and no praseodymium in the rare-earth content (Example A) and a second magnet having 2 weight % terbium and 75 weight % praseodymium of in the rare-earth content (Example B). The predicted intrinsic coercivity for the two hypothetical magnets were similar, 20.8 and 20.3 kilo Oersteds, respectively. Empirical results for actual first and second magnets samples having the stipulated compositions of Examples A and B were consistent with the hypothetical analyses in showing actual intrinsic coercivity Hcj of 19.95 and 19.31 kilo Oersteds, respectively. In conclusion, in this example, approximately the same intrinsic coercivity Hcj can be obtained when terbium is reduced by 1 weight % of the rare-earth content of the magnet with replacing 0.75 fraction of the neodymium with praseodymium (or about 70-75 weight % of the rare-earth content will be praseodymium, depending on the amount of Tb and Dy, for example). Exemplary results are presented in table 8.

TABLE 8
Exemplary Data

| | | Example A | Example B | |
|---|---|---|---|---|
| | | First | Second | |
| | | Magnet | Magnet | |
| Variable | Units | Value | Value | Exemplary Ranges |
| Tb | Wt % of | 3 | 2 | For weight % of rare-earth: |
| | Magnet | | | 0-20%, 1-20%, |
| | | | | 5-20%, 5-15% |
| Pr | Wt % of | 0 | 73 | 50+%, 50-90%, |
| | Rare Earth | | | 51-85%, 55-80%, |
| | | | | 70+%, 71+%, |
| | | | | 72+%, 73+%, 75+% |
| Dy | Wt % of | 0 | 0 | For weight % of rare-earth: |
| | Magnet | | | 0-25%, 5-25%, |
| | | | | 10-20%, 5-15% |
| Sinter T | ° C. | 1102 | 1090 | 1000-1200, 1020-1188, |
| | | | | 1040-1160 |
| Aging T* | ° C. | 630 | 630 | 580-680, 600-660, |
| | | | | 610-650, 620-640 |
| Result | Units | Mean | Mean | Range |
| Br | kGs | 11.7 | 11.6 | 10.0-13.5, 10.5-13.0, |
| | | | | 11.0-12.5, 10.0+, 11.0+ |
| Hcj | kOe | 20.8 | 20.3 | 17+, 18+, 19-25, 21+, |
| (BH)max | MGOe | 31.7 | 31.4 | 25-40, 27-38, 30-35, 31+ |
| Hk/Hcj | | 0.75 | 0.6 | |
| Density | gram/cm³ | 7.3 | 7.2 | 6-8.5, 6.5-8, 6.8-7.8, 7.0+ |

*An initial aging may be performed at various temperatures, e.g., about 580° C. to about 680° C.

### EXAMPLE V

This example considers actual magnets having both terbium and dysprosium. For a magnet having 3 weight % dysprosium, with the substitution of 0.75 fraction of the Nd with Pr, the terbium weight % of the magnet may be lowered from about 1.5% to about 0.5% without significant loss of intrinsic coercivity. With only 0.5 weight % (of the magnet), an approximate 20 kOe or greater intrinsic coercivity is expected.

TABLE 9
Permanent Magnets Having Both Terbium and Dysprosium

| Magnet Composition | | Hcj |
|---|---|---|
| (Pr₀Nd₁)_{27.5}Tb_{1.5}Dy₃Fe_{bal}Nb₁B_{1.1} | Sample 1A | 20.81 |
| | Sample 2A | 20.81 |
| Conventional | Mean | 20.81 |
| (Pr_{0.75}Nd_{0.25})_{27.5}Tb_{1.5}Dy₃Fe_{bal}Nb₁B_{1.1} | Sample 1B | 19.86 |
| | Sample 2B | 20.17 |
| Present | Mean | 20.02 |

Discussion of General Magnet Characteristics

While many terms have been mentioned or discussed, additional discussion is provided with regard to terms used to characterize a magnet or permanent magnet. As indicated, the, magnetic flux density inside a magnetized body is denoted by the symbol B. The magnetizing force (or magnetic field producing it) is denoted by the symbol H. The magnetic flux density and magnetizing force may be represented by the equation B=μH, in which the Greek letter, μ, symbolizes the permeability of the material and is generally a measure of the intensity of magnetization that can be produced in it by a given magnetic field. Units of B include teslas (T), webers per square meter (Wb/m²), and Gauss (Gs). Units for H include amperes per meter (A/m) and Oersted (Oe), for example. Exemplary units of μ are henrys per meter. Permanent-magnet materials are often characterized by quoting the maximum value of the product of B and H, (BH)ₘax which the material can achieve. This product (BH)ₘₐₓ may be considered a measure of the minimum volume of permanent-magnet material required to produce a required flux density in a given gap and is sometimes referred to as the energy product.

The saturation intrinsic induction Js is a measure of how strongly the material can be magnetized. Remanence or the remanent flux density Br is the residual magnetization left after the magnetizing field is removed, measured in, e.g., teslas. As discussed, the magnitude of a reverse magnetizing field necessary to reduce the intrinsic induction to zero is the intrinsic coercivity or coercive force H_{cj}, measured in, e.g., amperes per meter.

Exemplary Manufacture

As indicated, material of the REFeB type is an aspect of the present technique. This material is sometimes referred to as alloy or alloy material. In forming the material (alloy), the iron, boron, and rare-earth metal may each be used in amounts substantially corresponding to those desired in the final sintered product. The alloy can be formed by a number of methods. For example, the alloy can be prepared by arc-melting or induction melting the iron, boron and rare-earth metal together in the appropriate amounts under a substantially inert atmosphere such as argon and allowing the melt to solidify. The melt may be cast into an ingot or into strips.

For the material (alloy) that exists as an ingot or strips, the material can be converted to particulate form in a conventional manner known by those skilled in the art. The ingot or strips may undergo a crushing or pulverizing step in order to form the particulate material. Such conversion can be carried out in air at room temperature. For example, the material can be crushed by mortar and pestle and then pulverized to a finer form by jet milling. Such powder may also be produced by known ball milling procedures, jet milling, or known hydrogen treatment, for example. The particle size of the iron-boron-rare earth alloy of the present invention may vary. It can be as finely divided as desired. The alloy particulate can have a mean particle size up to 60 microns. For most applications, average particle size will range from about 1 to about 10 microns, or about 1 to about 7 microns, or about 3 to about 5 microns. It may be unusual, but the particulate material can even be up to 100 microns. While larger sized particles can be used, it is pointed out that as the particle size is increased, the coercive force obtainable may be lower because the coercive force generally varies inversely with particle size. In addition, as known in the art, the smaller the particle size, the lower the sintering temperature that may be employed due to adverse effects on the relatively small particles.

The material (alloy) exists prior to the application of a magnetic field. Once a magnetic field is applied, then particulate grains align themselves magnetically so that the principal magnetic phase is (RE)₂Fe₁₄B and the grains magnetically align along their easy axis. If the particulate (alloy) is exposed to an aligning magnetic field, it generally occurs before pressing and compacting the particulate into a green body, which is subsequently sintered. The aligning magnetic field may also be applied during the pressing and compacting of the particulate. The magnetic field that is applied is at least 17 kOe. The greater the magnetic alignment of the particulate grains (also referred to herein as particles), the better the resulting magnetic properties.

The particulate material (alloy) can be compressed or compacted into a green body of the desired size and density by any number of techniques known to those skilled in the art. Some of these techniques include hydrostatic pressing or methods employing steel dies. Compression may be carried out to produce a green body with as high a density as possible, since the higher its density, the greater the sintering rate. Green bodies having a density of about fifty percent or higher of theoretical are typically employed.

The green body may be sintered to produce a sintered intermetallic product of desired density. The green body may be sintered to produce a sintered intermetallic product wherein the pores are substantially non-interconnecting. Such non-interconnectivity generally stabilizes the permanent magnet properties of the product because the interior of the sintered intermetallic product or magnet is protected against exposure to the ambient atmosphere.

The sintering temperature may depend largely on the selected composition of the alloy and the particle size. The sintering temperature generally should be sufficient for sintering to occur in the selected alloy composition and to coalesce the particles. Sintering may carried out so that the pores in the sintered intermetallic product are substantially non-interconnecting. A sintered intermetallic product having a density of at least about 87 percent of theoretical is generally one wherein the pores are substantially non-interconnecting. Non-interconnectivity can be determined by standard metallographic techniques, such as optical electron micrographs of a cross-section of the sintered product. The maximum sintering temperature is usually one at which significant growth of the particles or grains does not occur, since too large an increase in grain size deteriorates magnetic properties such as coercive force. The green body may be sintered in a substantially inert atmosphere such as argon, and upon completion of sintering, the body can be cooled to room temperature in a substantially inert atmosphere.

A particular sintering range for a selected composition can be determined empirically, for example, by carrying out a series of runs at successively higher sintering temperatures and then determining the magnetic properties of the sintered intermetallic products. The sintering temperature may be in the range of about 950 to about 1200° C. for most compositions of this invention. The sintering time varies but may lie between one and five hours, or more.

The density of the sintered intermetallic product may vary, depending, for example, on the particular permanent magnet properties desired. To obtain a product with substantially stable permanent magnet properties, the density of the sintered intermetallic product is generally such that the pores are substantially non-interconnecting, which occurs usually at a density of about 87 percent or greater. However, for some applications, the density may be below 87 percent, such as the range from about 80 percent up to 100 percent. For example, at low temperature applications, a sintered intermetallic product having a density ranging down to about 80 percent may be satisfactory. The preferred density of the sintered intermetallic product is one which is the highest obtainable without producing a growth in grain size which would deteriorate magnetic properties significantly, since the higher the density the better are the magnetic properties. For iron-boron-rare earth sintered intermetallic products of the present invention, a density of at least about 87 percent of theoretical, i.e. of full density, and as high as about 96 percent of theoretical is preferred to produce permanent magnets with suitable magnetic properties which are substantially stable.

In the present technique, at sintering temperatures, as well as at room temperatures, the final sintered intermetallic product contains a major amount of the (RE)₂Fe₁₄B solid intermetallic phase. A major amount is greater than 50 percent by weight of the intermetallic product. Traces of other iron-boron-rare earth intermetallic phases may also be present. Sintered intermetallic products having the highest energy products are those having the smallest content of other iron-boron-rare earth intermetallic phases. In one embodiment, the final sintered intermetallic product is comprised predominately of the (RE)₂Fe₁₄B solid intermetallic phase, i.e. about 95 percent by weight or higher but less than 100 percent.

Sintering of the green body produces a sintered product which weighs about the same as the green body indicating no loss, or no significant loss of iron, boron, and rare-earth components. Standard chemical analysis of a sintered product should show that the rare earth and iron and boron content is substantially unaffected by the sintering process.

Magnetization of the present sintered intermetallic products of iron, boron and rare earth produces novel permanent magnets. The magnetic properties of the present sintered intermetallic products can be improved by subjecting them to a heat-aging process. The sintered intermetallic product may be heat-aged at an exemplary temperature within 400° C. below its sintering temperature, for example. In other embodiments, the aging temperature is within 300 to 100° C. below its sintering temperature. Heat-aging is carried out in an atmosphere such as argon in which the material is substantially inert. The particular temperature at which the material is heat-aged is determinable empirically. For example, the sintered product may be initially magnetized and its magnetic properties determined. It is then heated at a temperature below its sintering temperature, generally about 100° C. below its sintering temperature for a period of time, for example about 3 hours or longer, and thereafter, allowed to cool to room temperature and magnetized in the same manner and its magnetic properties determined. This procedure may be repeated at successively lower temperatures until a temperature is found at which the magnetic properties, i.e. intrinsic and/or normal coercive force, of the product show a marked improvement. The product can then be further aged at such temperature to increase the coercive force. Once the particular heat-aging temperature is determined for a particular system, the sintered product can be heat-aged immediately after sintering, if desired, simply by lowering the furnace temperature, i.e. furnace cooling, to the desired heat-aging temperature. The aging process may be conducted in two or more steps. For example, aging at 900° C. for 2 hours and then at 600° C. for 4 hours.

Heat-aging by furnace cooling to the desired aging temperature is preferred. It requires a shorter period of time and generally produces a product with an intrinsic and/or normal coercive force significantly higher than that produced by the technique of initially cooling the sintered product to room temperature and then heating it up to the proper heat-aging temperature. For beneficial results, the rate of furnace cooling should be slow with the particular furnace cooling rate being determinable empirically. Preferably, the furnace cooling rate may range from about 0.1 to about 20° C. per minute depending largely on the particular iron-boron-rare earth alloy used. In addition, the rate of furnace cooling may be carried out in a continuous manner or, if desired, by step cooling.

When magnetized, the heat-aged sintered intermetallic product of the present technique is useful as a permanent magnet. The resulting permanent magnet is substantially stable in air and has a wide variety of uses. For example, the permanent magnets of the present invention are useful in moderate temperature applications, such as computers, magnetic resonance imaging devices, and so on, and in high-temperature applications, such as motors, generators, and so forth.

If desired, the sintered bulk intermetallic product of the present invention can be crushed to a desired particle size preferably a powder, which is particularly suitable for alignment and matrix bonding to give a stable permanent magnet. Based on the foregoing, permanent magnet materials of the (RE)FeB type of the present technique may then be obtained having intrinsic coercive force (Hcj) values of at least 17 kOe. The corresponding maximum energy product values (BH)max are at least 31 MGOein certain embodiments.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A permanent magnet, comprising:
boron;
iron, cobalt, or M, or a combination thereof, wherein M comprises aluminum, copper, chromium, vanadium, niobium, or gallium, or zirconium, or any combination thereof; and
a rare-earth material comprising neodymium, at least 50 weight percent praseodymium, 0-20 weight percent terbium, and 5-25 weight percent dysprosium, wherein the permanent magnet comprises an intrinsic coercivity of at least 15 kilo Oersteds.

2. The permanent magnet of claim 1, wherein the permanent magnet comprises the phase Pr₂Fe₁₄B.

3. The permanent magnet of claim 1, wherein the rare-earth material comprises at least 28 weight percent of the permanent magnet.

4. The permanent magnet of claim 1, wherein the material of the permanent magnet prior to saturation is sintered at a temperature in the range of about 1000° C. to about 1200° C.

5. The permanent magnet of claim 1, wherein the material of the permanent magnet prior to saturation is aged at a first temperature in the range of about 850° C. to about 950° C. and at a second temperature in the range of about 580° C. to about 680° C.

6. The permanent magnet of claim 1, wherein the permanent magnet comprises a maximum energy product of at least 31 MGOe.

7. The permanent magnet of claim 1, wherein the permanent magnet comprises at a remanence of at least 11.6 kilo Gauss.

8. A machine comprising a permanent magnet, the permanent magnet comprising:
boron;
iron, cobalt, or M, or a combination thereof, wherein M comprises aluminum, copper, chromium, vanadium, niobium, or gallium, or zirconium, or any combination thereof;
a rare-earth material comprising neodymium, at least 50 weight percent praseodymium, 0-20 weight percent terbium, and 5-25 weight percent dysprosium, wherein the permanent magnet is adapted to operate in a temperature environment of at least 80° C. within the machine.

9. The machine of claim 8, wherein the permanent magnet comprises an intrinsic coercivity of at least 14 kilo Oersteds.

10. The machine of claim 8, wherein the rare-earth material comprises at least 28 weight percent of the permanent magnet.

11. The machine of claim 8, wherein the machine comprises a motor or generator.

12. The machine of claim 8, wherein the machine comprises a wind turbine.

13. A method of operating a motor or generator having a permanent magnet, the method comprising:
operating the motor or generator at an operating temperature of at least 80° C.; and
exposing the permanent magnet to the operating temperature of at least 80° C., wherein the permanent magnet comprises boron, iron, and rare-earth material, and wherein the rare-earth material comprises neodymium, at least 50 weight percent praseodymium, 0-20 weight percent terbium, and 5-25 weight percent dysprosium.

14. The method of claim 13, wherein the permanent magnet comprises an intrinsic coercivity of at least 17 kilo Oersteds.

15. A method of manufacturing a permanent magnet, the method comprising:
forming an alloy or ingot or strips comprising boron, iron, and rare-earth material, wherein the rare-earth material comprises neodymium, at least 50 weight percent praseodymium, 0-20 weight percent terbium, and 5-25 weight percent dysprosium;
converting the alloy or ingot or strips to particulates;
compacting and sintering the particulates; and
aging the compacted and sintered particulates.

16. The method of claim 15, comprising applying a magnetic field to the particulates or the compacted particulates, or a combination thereof, wherein the permanent magnet comprises a remanence of at least 10 kilo Gauss.

17. The method of claim 16, wherein the permanent magnet comprises an intrinsic coercivity of at least 17 kilo Oersteds.

18. The method of claim 15, wherein sintering comprises sintering the particulates at a temperature in the range of about 1000° C. to about 1200° C.

19. The method of claim 15, wherein the alloy or ingot or strips comprises cobalt to increase the Curie temperature of the permanent magnet.

20. The method of claim 15, wherein the alloy or ingot or strips comprises aluminum, copper, chromium, vanadium, niobium, or gallium, or zirconium, or any combination thereof.
